(19) United States
(12) Patent Application Publication
(10) Pub. No.: US 2021/0156195 A1
(43) Pub. Date: May 27, 2021

(54) SECURITY SHIELD

(71) Applicant: Alfredo Montalvo, Brooklyn, NY (US)

(72) Inventor: Alfredo Montalvo, Brooklyn, NY (US)

(21) Appl. No.: 16/698,944

(22) Filed: Nov. 27, 2019

(51) Int. Cl. E06B 9/06

(52) U.S. Cl. CPC E06B 9/0653; E06B 5/11; E06B 9/063

(57) ABSTRACT

An illustrated view of an exemplary security shield device for securing a window is presented. The security shield device is easy and efficient to install and use. Also, the security shield device is useful for allowing a user to still have full site out of the window when the security shield device is retracted. The security shield device is further useful for doors in homes and business alike.

### FIELD OF THE INVENTION

This invention relates to windows. More particularly, it relates to a security device for protecting break-in from a window.

### BACKGROUND

A window is an opening in a wall, door, roof or vehicle that allows the passage of light, sound, and sometimes air. Modern windows are usually glazed or covered in some other transparent or translucent material, a sash set in a frame in the opening; the sash and frame are also referred to as a window. Many glazed windows may be opened, to allow ventilation, or closed, to exclude inclement weather. Windows often have a latch or similar mechanism to lock the window shut or to hold it open by various amounts.

Types include the eyebrow window, fixed windows, single-hung and double-hung sash windows, horizontal sliding sash windows, casement windows, awning windows, hopper windows, tilt and slide windows (often door-sized), tilt and turn windows, transom windows, sidelight windows, jalousie or louvered windows, clerestory windows, skylights, roof windows, roof lanterns, bay windows, oriel windows, thermal, or Diocletian, windows, picture windows, emergency exit windows, stained glass windows, French windows, panel windows, and double and triple paned windows.

Security is freedom from, or resilience against, potential harm (or other unwanted coercive change) caused by others. Beneficiaries (technically referents) of security may be of persons and social groups, objects and institutions, ecosystems or any other entity or phenomenon vulnerable to unwanted change.

Security mostly refers to protection from hostile forces, but it has a wide range of other senses: for example, as the absence of harm (e.g. freedom from want); as the presence of an essential good (e.g. food security); as resilience against potential damage or harm (e.g. secure foundations); as secrecy (e.g. a secure telephone line); as containment (e.g. a secure room or cell); and as a state of mind (e.g. emotional security).

Intruders often come into houses through the window as the window is the weakest link in a protection of a home. Security systems for windows are usually a bar or an electronic monitor coupled to the window. Once these devices are installed they are difficult to remove or to place back onto the window once removed. They often block the pleasure of looking out the window and can be costly when it is an electronic monitoring system.

In light of the foregoing, it would be desirable to devise an improved window security shield device that would be removable or retractable to allow a use of the window by the owner or to secure the window during night time when most crime occurs. It would be further advantageous if the device were remotely operable such that a user would not have to go to the window to actuate the security shield device.

### BRIEF DESCRIPTION OF THE DRAWINGS

FIG. 1 is an illustrated view of an exemplary security shield device.

FIG. 2A is an illustrated view of a window with a retracted security shield device shown in FIG. 1.

FIG. 2B is an illustrated view of a window with a extended security shield device shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

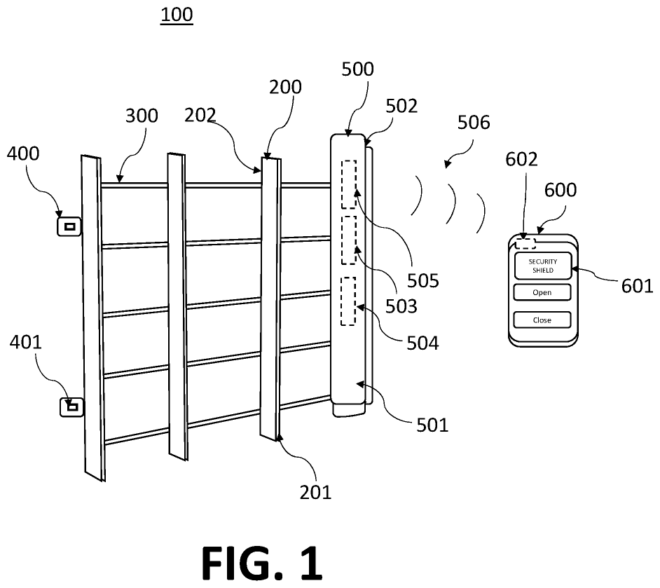

Referring to FIG. 1, an illustrated view of an exemplary security shield device 100 for securing a window is presented. The security shield device 100 is easy and efficient to install and use. Also, the security shield device 100 is useful for allowing a user to still have full site out of the window when the security shield device 100 is retracted. The security shield device 100 is further useful for doors in homes and business alike.

The security shield device 100 has a plurality of vertical bars 200, a plurality of horizontal bars 300, a plurality of locking tabs 400, a storage unit 500 and a controller 600. The plurality of vertical bars of the security shield device 100 is preferably a height of one of: 24 inches, 36 inches, 48 inches and 60 inches, however any other heights are hereby contemplated for custom made window sizes.

The controller 600 is preferably a cellular phone, however other types of controllers are hereby contemplated, including, but not limited to, remote control device, computing device, etc. The controller 600 has an app 601. The app 601 is a portal for a person to enter commands, such as by pressing an icon, or showing a status of the security shield device 100. The controller 600 further has a transceiver 602. The transceiver 602 can send and receive a wireless signaling 506. The wireless signaling 506 is preferably IEEE 802.11 (WiFi), however other signaling is hereby contemplated, including, but not limited to, IEEE 802.15)(Bluetooth®, cellular signaling, etc.

The storage unit 500 of the security shield device 100 has an outside 501 and an inside 502. The storage unit 500 is useful for storing the security shield device 100 when in a retracted configuration. The inside 502 of the storage unit 500 has a computing device 503, a power source 504 and a transceiver 505. The transceiver 505 can send and receive the wireless signaling 506. The transceiver 505 is communicatively coupled to the controller 600 by the wireless signaling 506.

The computing device 503 encodes and decodes the wireless signaling 506 received via the transceiver 505. The computing device 503 sends status messages to the controller 600 for display. The computing device 503 receives commands from the controller 600 for operation of the security shield 100. When a command from the controller 600 is received the computing device 503 performs the operation corresponding to the command. The operation is preferably one of: open and close. The open command expands the security shield device 100 for use and the close command retracts the security shield device 100 for storage into the inside 502 of the storage unit 500.

The computing device 503 is electrically coupled to the power source 504. The transceiver 505 is further communicatively coupled to the computing device 503 and electrically coupled to the power source 504. The power source 504 is preferably a rechargeable battery, however other power sources are hereby contemplated, including, but not limited to, disposable battery, AC/DC current, Nicad battery, etc.

The plurality of vertical bars 200 are preferably made of a metal material, such as steel, aluminum, titanium, etc., however other materials are hereby contemplated, including, but not limited to, poly-vinyl chloride (PVC), hard plastic, etc. Each of the vertical bars 200 are substantially the same height. The vertical bars 200 have a front 201 and a back 202.

The plurality of horizontal bars 300 are preferably telescopic, such that the horizontal bars 300 are retractable and expandable. The plurality of horizontal bars 300 are preferably made of a metal material, such as steel, aluminum, titanium, etc., however other materials are hereby contemplated, including, but not limited to, poly-vinyl chloride (PVC), hard plastic, etc.

Each of the plurality of horizontal bars 300 are coupled to the back 202 of at least one of the vertical bars 200. Each of the vertical bars 200 are equally spaced and perpendicular to each of the horizontal bars 300, thus the security shield device 100 is configured to a grid formation. The horizontal bars 300 are hollow tubes. The horizontal bars 300 preferably allow the device 100 to slide together to a compact style and retract into the storage unit 500 when not in use. The horizontal bars 300 are configured to align the vertical bars 200 such that the vertical bars 200 remain vertical and are remain aligned to be equally spaced.

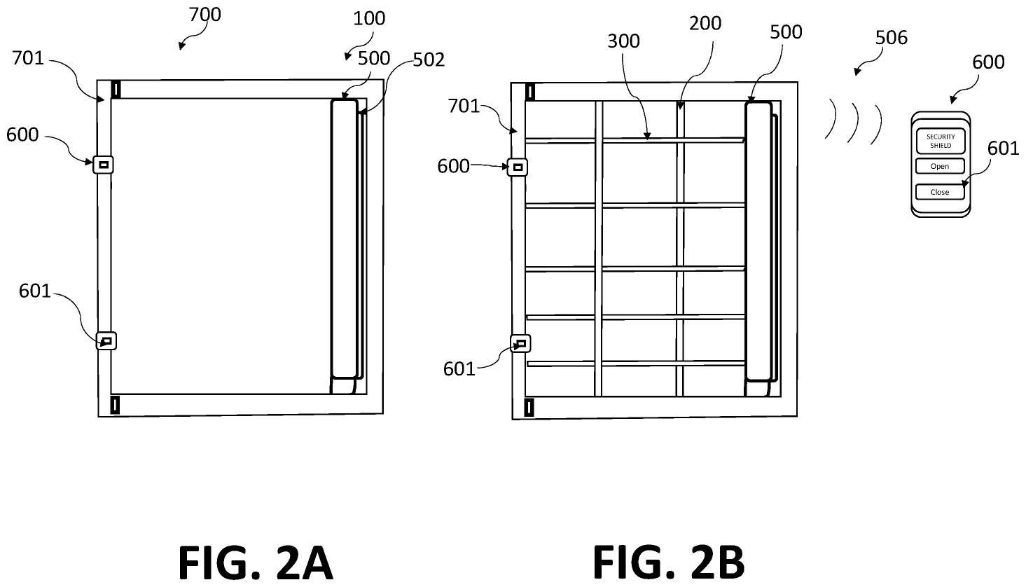

The plurality of locking tabs 400 are coupled to a window frame 701 (See FIG. 2A and FIG. 2B) of a window 700 (See FIG. 2A and FIG. 2B). The locking tabs 400 are controlled by the controller 600. When the security shield device 100 is fully expanded, the security shield device 100 is configured to couple to the locking tabs 400. A command is sent by the controller 600 to instruct a locking mechanism 401 of the locking tabs 400. When the command to retract the security shield device 100, the first command received from the controller 600 instructs an unlocking of the locking tabs 400 such that the security shield device 100 can then retract.

Moving to FIGS. 2A and 2B, an illustrated view of a retracted and expanded security shield device 100 shown in FIG. 1 is presented.

FIG. 2A presents an illustrated view of the security shield device in an open or retracted condition. The window 700 has the frame 701. The locking devices 600 being coupled to the frame 701 of the windows 700. The security shield device 100 is coupled to the inside 502 of the storage unit 400. Thus, the security shield device 100 is configured to be open or retracted such that a person can have an unobstructed view of an outside.

In FIG. 2B, the security shield device 100 is presented in a closed or expanded condition, thus providing security for the owner and preventing entry through the window by another person.

The app 601 of the controller 600 is actuated and the security shield device 100 is expanded or closed. The wireless signal 506 is sent to instruct the security shield device 100 to expand. The horizontal bars 300 are configured to telescope outward thus expanding the horizontal bars 300 and equally distancing the vertical bars 200. When fully expanded, the security shield device 100 engages the locking devices 600.

A command is sent via wireless signaling 506 from the app 601 of the controller 600 to the security shield device 100. The locking mechanism 601 is actuated and the security shield device 100 is locked into an expanded condition.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A security shield device for securing a window, the security shield device comprising:
a plurality of vertical bars, each of the vertical bars having a front and a back;
a plurality of horizontal bars, each of the horizontal bars coupled to the back of at least one of the plurality of vertical bars;
a storage unit, the storage unit having an outside and an inside,
wherein when the plurality of vertical bars and the plurality of horizontal bars being configured to be stored in the storage unit;
a power source, the power source being coupled to the inside of the storage unit;
a computing device, the computing device being coupled to the inside of the storage unit, wherein the computing device being electrically coupled to the power source;
a transceiver, the transceiver being configured to send and receive wireless signaling, wherein the transceiver being coupled to the inside of the storage unit, wherein the transceiver being communicatively coupled to the computing device, and wherein the transceiver being electrically coupled to the power source;
a controller, the controller having an app and a transceiver, the app being configured to send commands to the transceiver, wherein the transceiver being configured to send wireless signaling to the transceiver of the storage unit; and
a plurality of locking devices, each of the locking devices having a locking device, and wherein the locking device being coupled to a frame of a window.

2. The security shield device of claim 1, wherein each of the vertical bars having a height being twenty-four (24) inches.

3. The security shield device of claim 2, wherein each of the vertical bars being substantially the same height as the others of the vertical bars.

4. The security shield device of claim 1, wherein the horizontal bars being hollow.

5. The security shield device of claim 1, wherein the horizontal bars being telescopic.

6. The security shield device of claim 1, wherein the horizontal bars being expandable.

7. The security shield device of claim 1, wherein the horizontal bars being retractable.

8. The security shield device of claim 1, wherein the wireless signaling being configured to send and receive signaling being compliant with the IEEE 802.11 (WiFi) standard.

9. The security shield device of claim 1, wherein the controller configured to send a command to expand the security shield device.

10. The security shield device of claim 1, wherein the controller configured to send a command to retract the security shield device.

11. The security shield device of claim 1, wherein the controller configured to send a command to unlock the plurality of locking devices.

12. The security shield device of claim 1, wherein the controller configured to send a command to lock the plurality of locking devices.

13. The security shield device of claim 1, wherein the vertical bars being made of a metal material.

14. The security shield device of claim 13, wherein the metal material being steel.
